(19) United States
(12) Patent Application Publication
(10) Pub. No.: US 2021/0201072 A1
(43) Pub. Date: Jul. 1, 2021

(54) PHOTOSET CLUSTERING

(71) Applicant: Hewlett-Packard Development Company, L.P., Spring, TX (US)

(72) Inventors: Qian Lin, Palo Alto, CA (US); Nicholas Moe Khosravy, Palo Alto, CA (US)

(73) Assignee: Hewlett-Packard Development Company, L.P., Spring, TX (US)

(21) Appl. No.: 16/754,229

(22) PCT Filed: Oct. 31, 2017
(86) PCT No.: PCT/US2017/059354

§ 371 Date: Apr. 7, 2020

(51) Int. Cl. G06K 9/62; G06K 9/03; G06K 9/00

(52) U.S. Cl. CPC G06K 9/6219; G06K 9/036; G06K 2209/27; G06K 9/6201; G06K 9/00302

(57) ABSTRACT

Indexing a photoset for retrieval of representative photos of an event is disclosed. Photos of a photoset are clustered into taxa of a hierarchical event taxonomy. A representative photo from each taxa is selected based on an object image quality.

### BACKGROUND

Digital photography is a form of photography that uses cameras having arrays of electronic photodetectors to capture images focused by a lens, as opposed to an exposure on photographic film. Digital cameras can include dedicated devices such as digital single lens reflex cameras and integrated devices such as mobile camera phones. The captured images are stored as a computer file ready for further digital processing, viewing, digital publishing or printing. The computer file, or photo, can include metadata such as date and time of the image and geographical location information that may be provided from hardware included with the camera or other labeling during digital processing. The amount of computer memory used for each photo is relatively small, which permits consumers to amass many photos in their digital photo collections. Consumers can able to manage their digital photo collections with computing devices including mobile devices and general-purpose computers.

### BRIEF DESCRIPTION OF THE DRAWINGS

FIG. 1 is a block diagram illustrating an example method.

FIG. 2 is a block diagram illustrating an example method of the example method of FIG. 1.

FIG. 3 is a schematic diagram illustrating an example hierarchical event taxonomy of a photoset.

FIG. 4 is a block diagram illustrating an example method implementing the example method of FIG. 2.

FIG. 5 is a block diagram illustrating an example system to implement the example method of FIG. 1.

### DETAILED DESCRIPTION

Digital photography includes several conveniences. An advantage of digital photography is the low recurring cost, as users often do not purchase photographic media on which to store the photos. Processing costs may be reduced or even eliminated. Digital cameras also tend also to be easy to carry and to use and are often integrated into other devices such as mobile computing devices and phones. According to one estimate, over eighty-five percent of digital photographs are currently taken with a smartphone. Because of the conveniences, users tend to accumulate a large number of photos on their mobile devices, on dedicated storage media, or in network-based storage systems as photo repositories, or photosets. This can present a challenge for users as they later attempt to sort or retrieve selected photos from the photoset.

A method and system to index a photoset and to provide retrieval of representative photos of the photoset are described. The photos of the photoset are clustered into a hierarchical taxonomy of events using such criteria as time and date of the photo, the location of the photo, and people in the photo. Such criteria can be determined from metadata stored with the photo or from object recognition techniques. The indexing includes identifying representative photos from each taxon of the hierarchical taxonomy. The representative photos can be output, such as printed with a printing device implementing the method in a selected format. Additionally, photographs can be compared to the indexed photoset to find matching photos in the photoset. For example, a printed photograph can be scanned and a resulting image compared to the photoset to find a similar photo based on criteria such similar objects including people in the photo.

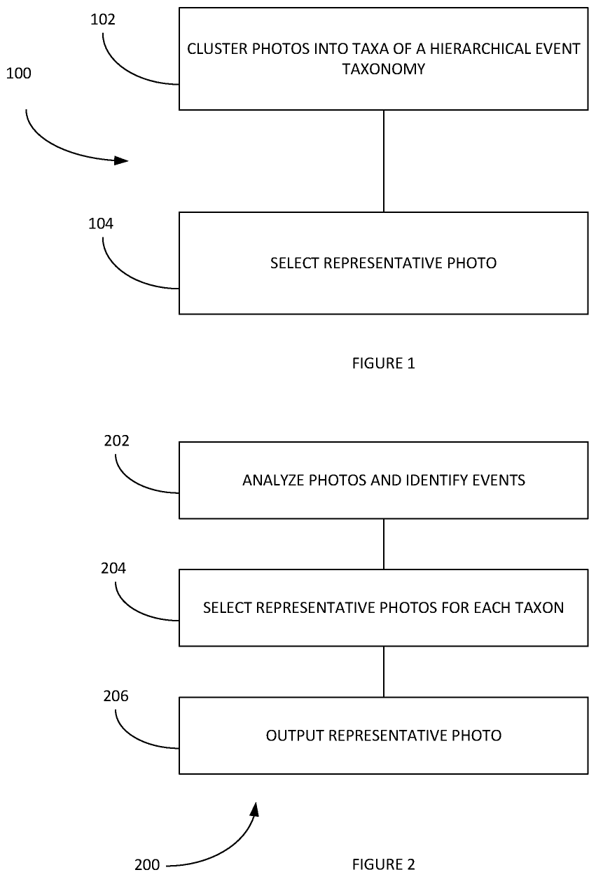

FIG. 1 illustrates an example method 100 for indexing a photoset for retrieval of representative photos of an event. A plurality of photos of a photoset are clustered into a plurality of taxa of a hierarchical event taxonomy at 102. For example, the photos can be clustered into events based on a criteria and that cluster can be further clustered into a sub-event based on other criteria. For instance, photos can be clustered together in a time-based event if the photos share a characteristic that they were taken at a particular time. The time-based event cluster can be further clustered into a location-based event if the photos were taken at a particular location. The location-based event can be further clustered into a people-based event if they share the same people in the photos. Other event clusters are contemplated. This results in hierarchical taxonomy of a time-based taxon including location-based taxa further including people-based taxa. A representative photo from each taxon is selected based on an object image quality at 104. In one example, object image quality is based on facial features. For instance, the facial features of people in the photos are detected for image quality, and the photo having a selected quality of facial features is chosen as the representative photo.

The example method 100 can be implemented to include a combination of one or more hardware devices and computer programs for controlling a system, such as a computing system having a processor and memory, to perform method 100 to cluster a photoset and select a representative photo. Examples of computing system can include a mobile device such as a tablet or smartphone, a personal computer such as a laptop, and a consumer electronic device such as digital camera, video game console, digital video recorder, or other device. Method 100 can be implemented as a computer readable medium or computer readable device having set of executable instructions for controlling the processor to perform the method 100. In one example, computer storage medium, or non-transitory computer readable medium, includes RAM, ROM, EEPROM, flash memory or other memory technology, that can be used to store the desired information and that can be accessed by the computing system. Accordingly, a propagating signal by itself does not qualify as storage media. Computer readable medium may be located with the computing system or on a network communicatively connected to the computing system and the photoset. Method 100 can be applied as computer program, or computer application implemented as a set of instructions stored in the memory, and the processor can be configured to execute the instructions to perform a specified task or series of tasks. In one example, the computer program can make use of functions either coded into the program itself or as part of library also stored in the memory.

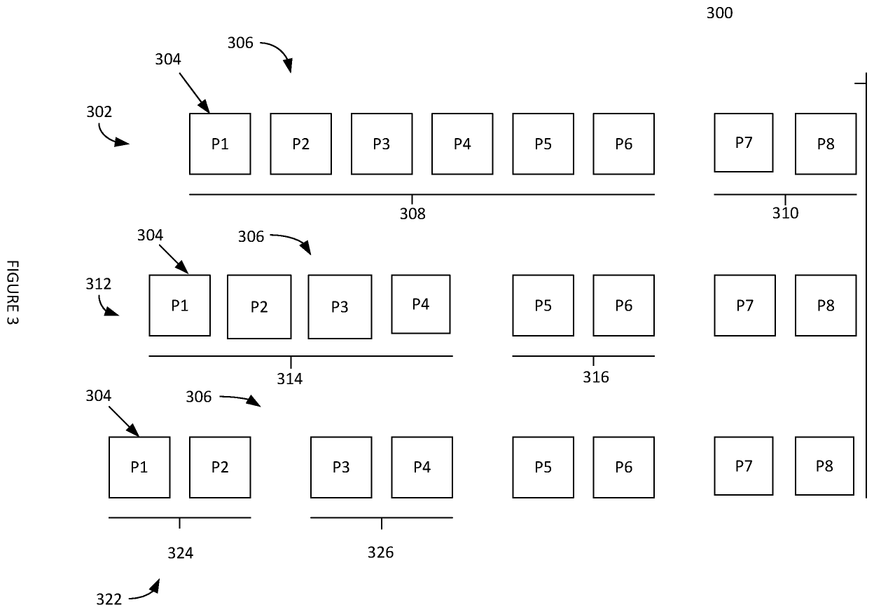

FIG. 2 illustrates an example method 200 implementing method 100. The photos of the photoset are analyzed and events are identified at 202 as the photos are clustered into taxa of a hierarchical event taxonomy. In one example, the structure of the hierarchical event taxonomy is predefined, and in another example, the structure of the hierarchical event taxonomy is selected once the photos are analyzed to determine their content. The hierarchical event taxonomy includes a root taxon or root taxa based on a selected first event characteristic. The hierarchical event taxonomy includes a taxon having sub-taxa. The sub-taxa are based on a selected second event characteristic. In one example, a sub-taxon of the sub-taxa is further clustered into additional sub-taxa. The additional sub-taxa are based on a selected third event characteristic. The characteristics can include a time-based event, a location-based event, a people-based event, an object-based event, as well as many other characteristics of the photos. In one example, the photos can be clustered into time-based event taxa. Photos clustered within a time-based event taxon can be further clustered into location-based event taxa. Still further, photos clustered with a location-based event taxon can be further clustered into people-based event taxa.

Event characteristics can be based on metadata or information stored with the file of the photograph, or photo. For example, time-based events can be determined from date and time information, and location-based events can be determined from geographic location information. In one example, the camera or other image processing software can provide the metadata automatically to the image. In another example, a user can selectively input the information to be included with the image, such as labels, ratings, or other information. In still another example, facial or object recognition tools, or machine learning tools can be used to provide the information stored with the photo.

In an illustration of the photos are arranged according to a sequence of time the photo was taken, such as from earliest in time to latest in time, based on the date and time metadata. Two photos are adjacent to each other in the sequence of time if there is no intervening photo taken at a time between the two. In this example, photos that are proximate each other in the sequence are clustered together in a time-based event if the difference in time between the photos in the sequence is outside of a selected threshold. For instance, adjacent photos are clustered together in a time-based event if the difference in time between them is less than the selected threshold. Adjacent photos are placed in separate clusters of time-based events if the difference in time between them is greater than the selected threshold. The selected threshold can be a fixed amount of time for clustering the photoset or a variable threshold based on other factors. Additionally, the selected threshold can be varied based on determined usage patterns.

Users often capture photographs unevenly across time. For instance, the number of photos taken per day or per month often fluctuates over the course of a year. More photos are taken during significant occurrences in a user's life. For example, a user may take more photographs during vacations, holidays, birthdays, and school programs. Photos from these occurrences can be clustered together in, for example, the time-based events.

The photos can be clustered together in taxa, or further clustered together in subs taxa, of location-based events. Once the photos are clustered together in the time-based events of the example, each time-based event can be further clustered together according to another criteria, such as in location-based events. For instance, users on a vacation during a given period of time may take photographs at more than one location. For instance, photos are clustered together in a location-based event if the difference in geographical location, such as distance between geographic location as determined from metadata or proximity to a particular object of interest as determined from comparing geographic location to a geographic location of the particular object, is less than the selected threshold. Photos can be placed in separate clusters of location-based events if the difference in geographic location, such as distance between them or proximity to a known object of interest, is greater than the selected threshold. The selected threshold can be a fixed amount of geographic distance for clustering the photoset or a variable threshold based on other factors. Additionally, the selected threshold can be varied based on determined usage patterns.

The photos can be clustered together in taxa, or further clustered together in sub taxa, of object-based events such as people-based events. For example, once the photos are clustered together in location-based events of time-based events, each location-based event can be further clustered together according to an object based criteria such as people-based events. In one example, the photos of the cluster can be analyzed to determine a number of faces in each photo and photos having the same number of faces can be further analyzed to determine if the faces are the same in the photos, which would indicate whether photos include the same people. The photos of same people can be clustered together in a people-based event. Photos with different amounts of faces or with different groups of the same amount of faces can be clustered in separate people-based events. The photos can be analyzed with object recognition tools to determine the objects in the photos. For example, the photos can be analyzed with facial recognition tools to determine the number of faces and whether the faces match each other.

In one example, information regarding the structure of the hierarchy or the photo's position relative to the hierarchy can be stored with each photo as part of metadata. In another example, information regarding the structure of the hierarchy can be stored in a separate data structure such as an array or database. Example information stored with the photo can include date and time information, location, number of faces, facial features (whether the subject is smiling, frowning) for each face, the position within an event hierarchy,

FIG. 3 illustrates an example progression 300 of the clustering of a plurality of photos of a photoset into a plurality of taxa of a hierarchical event taxonomy at 102. In a first stage 302, the photos 304 of a photoset 306 are analyzed and arranged according to a sequence of time the photo was taken, such as earliest in time to latest in time, or photos P₁ to P₈ in the example. In the example, photos P₁ to P₆ are clustered together in a first time-based event 308 and photos P₇ and P₈ are clustered together in a second time-based event 310, based on whether the photos were taken proximate in time to an adjacent photo in the sequence.

In a second stage 312, the photos 304 of photoset 306 are further clustered together in location-based events. In the example, photos P₁ to P₄ were taken in proximate in geographic location to each other and photos P₅ and P₆ were taken at a different geographic location than photos P₁ to P₄. Thus, photos P₁ to P₄ are clustered together in a location-based event 314 and photos P₅ and P₆ are in a separate cluster 316.

In a third stage 322, the photos of photoset 306 are still furthered clustered together in people-based events. Facial recognition tools can determine that photos P₁ and P₂ include the same people while photos and thus are clustered together in cluster 324 P₃ and P₄ include different people. Other examples are contemplated.

The photos are also analyzed to select a representative photo, such as a representative photo from each taxon at 204 in FIG. 2. Photos in the taxa can be analyzed for a quality such as focus, color, blur, sharpness, position of objects within the frame, or other characteristics and provided a score based on the selected characteristic. As an example, objects within the photos can be analyzed for a quality and provided with an object image quality score. The scores of the photos within the taxon can be compared to each other to determine a representative photo. In some examples, a cumulative score of weighted characteristics of a photo or object, or an average score of scores of multiple objects can be used to determine a representative photo. For instance, the photo with the highest score, or highest average score, can be selected as the representative photo. Information regarding whether the photo is a representative photo of the taxa as well as the object image quality score can also be stored with the photo as part of the computer file or regarding the photo in a separate data structure.

In one example of selecting a representative photo at 204, facial features of people in the photos are used as the characteristic to determine the representative photo. For example, the faces of each person in the photos can be analyzed and given a facial quality score based on facial image quality. A facial image quality score can be determined using facial attributes such as normalized eye size, brightness, sharpness, selected facial expression, whether a portion of the face is obscured, or other attributes. For instance, the photo with the highest facial image quality score, or highest average score, can be selected as the representative photo.

The representative photo from each taxon can be output at 206. In one example, the representative photo from each taxon can be printed with a printing device to provide individual prints, a format for a photobook, or a collage. The printing device can be operably coupled to a computing device implementing method 200 or the printing device can be configured to implement method 200. In another example of the representative photo being output at 206, the representative photos can be output to a display device, such a monitor operably coupled to a computing device implementing method 200, to provide thumbnails, a photo slide show, or presentation. In some examples, photos in addition to the representative photos may be output. In one example of method 200, a user may provide a multiplicity of photographs as a photoset to be indexed, which may be clustered into a plurality of root events, such as time-based events in the example of FIG. 3, and method 200 can be implemented to automatically output, such as print, a particular subset of representative photos in a selected format, such as prints for a photobook.

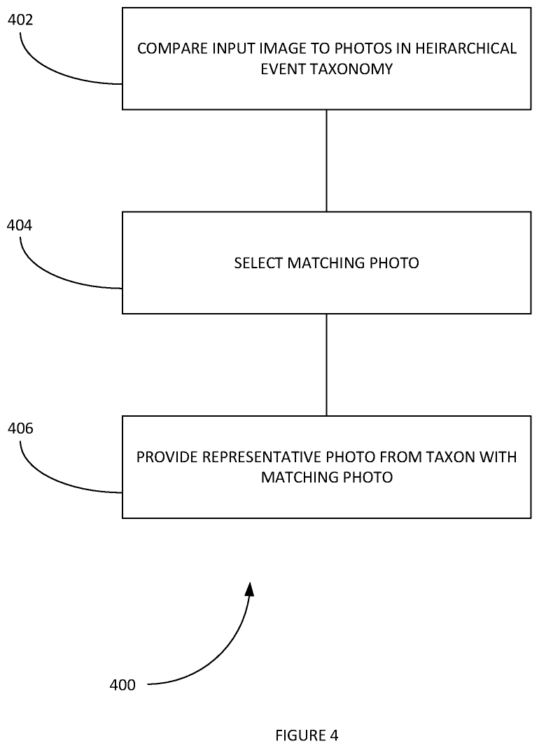

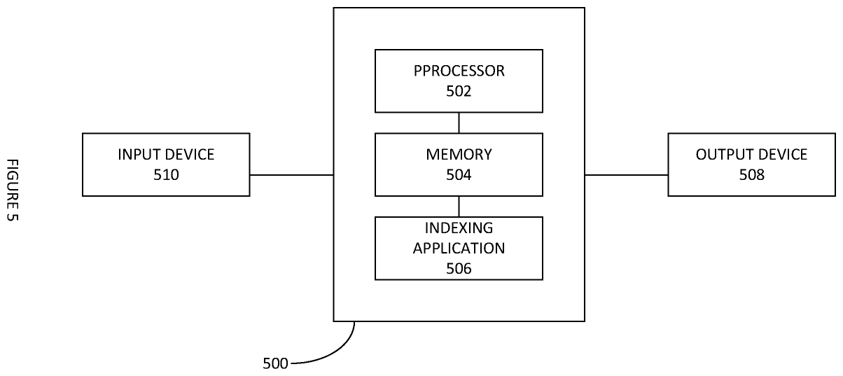

FIG. 4 illustrates an example method 400 implementing the method of FIG. 2. In the example method 400, and image is used to retrieve related representative photos from the hierarchical event taxonomy. An input image is compared to the photos in the hierarchical event taxonomy at 402. In one example, the input image can be received from a scan or imaging technique of a printed or published photograph that is provided as a digital file. For example, a user may create an image via the camera on a smartphone by photographing or scanning another photographic print or display of a photo on a monitor. In another example, the input image is provided directly from a digital file, such as a thumbnail or a photo in a digital photobook. In one example, a photograph is printed with a printing device and scanned to provide an input image. In another example a photograph from a digital social media feed is received as an input image.

The input image can be compared to the photos of the photoset, and in one example compared to more photos than the representative photos of the hierarchical event taxonomy, in order to detect a matching photo from the hierarchical event taxonomy. A match can include an identical match between the image and the photo in the hierarchical event taxonomy, a match that is more similar between the image and the determined match than any other photo in the photoset, or a match of the image and a similar photo in the photoset. Accordingly, a matching photo can be identical, most similar in the photoset to the image, similar to the image, or other criteria.

Several examples of comparing the input image to the photos of the photoset at 402 are contemplated. In one example, the comparison at 402 can include a comparison of facial features between faces of the people in the input image and the faces of the people in the photos of the photoset to determine a match. For instance, the comparison may include a determination of whether a photo of the photoset includes the same person or people as the input image and whether the people are arranged in the same order. If the input image does not include facial features, other objects such as pets or landmarks can be detected and then checked against the objects in the photos of the photoset for a comparison. In still another example, hash files of the input image are compared to photos of the photoset, or other digital information is used as a comparison rather than object recognition.

The matching photo is selected from the photoset at 404. The file of the matching photo can be read to determine its taxon in the hierarchical event taxonomy, super-taxa, sub-taxa, and other related taxa, and which photos have been selected as representative photos of the taxa.

The representative photo from the taxon of the matching photo or related taxa can be provided as an output at 406. In one example, a single representative photo from the taxon corresponding with the matching photo is output. In another example, representative photos from the sub-taxa of the root taxon, such as the time-base event taxon are output. In an example of the illustration of FIG. 3, if the matching photo is included in a people-based event, photos output can include representative photos from each of the sub taxa of the time-based event taxon corresponding with the people-based event. In some examples, photos in addition to the representative photos or instead of the representative photos, such as the matching photo, can be output at 406. In one example, the output at 406 can include printing the photos with a printing device or displaying the photos with a display device. In one example, a set of relevant, representative photos can be printed as the output at 406 based on an input image provided as a comparison at 402.

FIG. 5 illustrates an example system 500 to implement method 100. The system 500 includes a processor system having a processor unit including a processor 502 and memory 504. Depending on the configuration and type of computing device, memory 504 may be volatile (such as random access memory (RAM)), non-volatile (such as read only memory (ROM), flash memory, etc.), or some combination of the two. The system 500 can take one or more of several forms. Such forms include a tablet, a personal computer, a workstation, a server, a handheld device, a consumer electronic device (such as a video game console or a digital video recorder), a printing device such as an inkjet printer, or other, and can be a stand-alone device or configured as part of a computer network. The memory 504 can store an application 506 as set of computer executable instructions for controlling the computer system 500 to perform method 100.

The system 500 can include communication connections to communicate with other systems or computer applications. In the illustrated example, the system 500 is operably coupled to an output device 508 to output representative photos such as a printing engine to print representative photos. Also, the system can be operably coupled to an input device 510 to receive an image provided as a comparison to the hierarchical event taxonomy. For example, the input device 510 can include a scanner or smart phone camera to receive a scanned imaged of a printed photograph for comparison to the hierarchical event taxonomy.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
clustering a plurality of photos of a photoset into a plurality of taxa of a hierarchical event taxonomy; and
selecting a representative photo from each taxa based on an object image quality.

2. The method of claim 1 wherein the plurality of taxa of the event taxonomy includes time-based taxa, location-based taxa, and people-based taxa.

3. The method of claim 2 wherein photos of the time-based taxa are clustered based on a selected time difference between sequential photos from time and date metadata of the photos.

4. The method of claim 2 wherein the location-based taxa include subsets of photos in the time-based taxa.

5. The method of claim 1 including printing the representative photo from each taxa.

6. The method of claim 1 including comparing an image to the photoset, selecting the event taxonomy corresponding with the image, and providing the plurality of photos from the event taxonomy.

7. The method of claim 1 wherein object image quality is based on facial image quality.

8. The method of claim 7 wherein facial image quality is based on facial expression from a facial recognition.

9. A non-transitory computer readable medium to store computer executable instructions to control a processor to:
cluster a plurality of photos of a photoset into a plurality of taxa of a hierarchical event taxonomy; and
select a representative photo from each taxa based on a facial image quality.

10. The computer readable medium of claim 9 including storing information regarding the hierarchical event taxonomy with each photo.

11. The computer readable medium of claim 10 wherein the storing information includes storing the information as metadata with each photo.

12. The computer readable medium of claim 9 wherein the hierarchical event taxonomy includes time-based event taxa having location-based event sub-taxa having people-based event sub-taxa.

13. A system, comprising:
a memory device to store a set of instructions; and
a processor to execute the instructions to:
cluster a plurality of photos of a photoset into a plurality of taxa of a hierarchical event taxonomy;
select a representative photo from each taxa based on an object image quality; and
output a selected representative photo from the each representative photo based on an input image.

14. The system of claim 13 wherein the input image is compared to the photos of the photoset to determine a matching photo.

15. The system of claim 14 wherein the input image is compared to the photos of the photoset based on hash value.
